(19) United States
(12) Patent Application Publication
(10) Pub. No.: US 2024/0233695 A1
(43) Pub. Date: Jul. 11, 2024

(54) GAMING AUDIO INTERFACE APPARATUS

(71) Applicant: inMusic Brands, Inc., Cumberland, RI (US)

(72) Inventors: Christopher PARLON, Cumberland, RI (US); David GILL, Cumberland, RI (US); Walter SKORUPSKI, Cumberland, RI (US); Henry LEE, Cumberland, RI (US)

(73) Assignee: inMusic Brands, Inc., Cumberland, RI (US)

(21) Appl. No.: 17/896,581

(22) Filed: Aug. 26, 2022

Related U.S. Application Data
(63) Continuation of application No. 16/515,237, filed on Jul. 18, 2019, now Pat. No. 11,100,907.

(51) Int. Cl. G10H 1/00; G10H 1/34; G10H 1/46

(52) U.S. Cl. CPC G10H 1/0033; G10H 1/0008; G10H 1/348; G10H 1/46; G10H 2220/096; G10H 2220/116; G10H 2240/325

(57) ABSTRACT

A standalone gaming audio interface device offers an all-in-one solution for simultaneously connecting to multiple PCs by using two 2×USB connections as well as an optical connection and can send and receive multiple stereo audio streams with multiple audio routing configurations so that a user can select from which PC the specific audio sources can be sent and received. The device utilizes an integrated solution for enhanced audio for headphones and headset mic, as well as an onboard digital signal processor for equalization, noise gate, compression, de-essing, high-pass filter, reverb, echo/delay, pitch, and gender effects.

### FIELD OF THE INVENTION

The disclosure relates to audio equipment, and, more particularly, to an audio interface device for the streaming requirements of a gaming environment.

### BACKGROUND OF THE INVENTION

Live, on-line playing of video games over the Internet has become immensely popular. People who stream (broadcast) performances over the internet typically use multiple personal computer (PC) setups. As used herein the acronym “PC” is intended to encompass Mac personal computer available from Apple, Inc., as well as all other personal computer models, including those architectures which evolved from the original IBM personal computer model. Multiple PC setups enable users to host Central Processing Unit (CPU) heavy applications/programs on multiple PCs to capture and broadcast the highest quality performance available. The multiple PC configuration is extremely popular in the streaming gamer community, where users use one PC to run their game at the highest possible settings and another PC to run their broadcast at the highest possible settings.

In the current streaming hardware market, there are no interfaces for connecting to multiple PCs at once without additional analog cables, which can introduce ground noise (hum) and lack the fidelity of a digital connection. Currently available analog connections do not allow for multiple channels of audio streams as well. In currently available solutions there is typically only one stereo channel available for users. Such analog solution also does not allow for configuration of which audio stream is sent from their connected PC. The audio sent from a connected PC contains only what is being sent to the PC main/headphone audio outputs.

Accordingly, a need exists for a device for that can simultaneously connect to multiple PCs in a gaming environment and that can send and receive multiple channels of stereo audio.

Another need exists for a device that offers multiple stereo audio streams for multiple audio routing configurations and avoids any unwanted noise.

A further need exists for a device that enables a user to select from which of multiple PC specific audio sources can be sent and received.

A still further need exists for a device that offers the ability to receive game audio from a game PC, and send the game audio to a broadcast/stream PC.

A still further need exists for a device that offers audio processing functionality, such as any of equalization, noise gate, compressor, de-esser and high-pass filter effects, as well as modulation/time based and pitch effects (Reverb, Echo/Delay, Pitch, and Gender) and sample playback.

### SUMMARY OF THE INVENTION

Disclosed is a gaming audio interface device designed specifically for the streaming requirements of an entry-to-pro-level streaming gamer who wants a great sounding audio interface that matches their gaming setup. The system provides all of the necessary audio I/O and controls in one device and features a carefully designed user interface so that can be rapidly understood. The system also includes control panel software that guides users through setup, allows advanced users to further configure the onboard controls, as well as access advanced settings such as headphone mix settings, configuring effects and sound enhancements, etc.

The disclosed device solves offers an all-in-one solution for simultaneously connecting to multiple PCs by using to 2×USB connections as well as an optical connection. The disclosed system's 2×USB connection can send and receive 4-channels of stereo USB audio. These four stereo sources can be configured so that a user can select from which PC specific audio sources can be sent and received. For example, users will have the ability to receive their game audio from their game PC, and send that audio to their broadcast/stream PC. The disclosed system offers users four USB stereo sources for multiple audio routing configurations and avoids any unwanted noise from analog connections in their setup.

The device utilizes an integrated solution for enhanced audio for headphones and clear voice for headset mic, as well as onboard DSP for equalization, Gate, compressor, de-esser and high-pass filter effects, as well as modulation/time based and pitch effects (Reverb, Echo/Delay, Pitch, and Gender). The system utilizes a software control panel for editing controls, signal routing, and other audio and LED routing/selection. The control panel enables control launching, recording, editing, loading samples, and handling of MIDI to HID Control for key-binding the various buttons/controls of the user interface and is viewable on a connected device having a visual display.

According to one aspect of the disclosure, an apparatus for mixing gaming audio signals comprises: a plurality of audio inputs at least one of which is configurable for operative coupling to a remote executable gaming process generating a first audio signal stream; a plurality of audio outputs at least one of which is configurable for operative coupling to a remote executable broadcast process; a user interface comprising a plurality of controllers; and a processor operatively coupled to the plurality of audio inputs, the plurality of audio outputs, a memory and user interface and having an operational mode configured to: receive a second audio signal stream generated with a transducer coupled to another of the plurality of audio inputs different from the at least one audio input; modify the second audio signal stream with one of a plurality audio processing algorithms selectable with the user interface; generate a third audio signal stream comprising audio signal playback of at least one audio sample stored in the memory; combine the first audio signal stream and one of the second audio signal stream and third audio signal stream into a combined audio signal stream, and provide the combined audio signal stream to the at least one audio outputs configurable for operative coupling to the remote executable broadcast process. In embodiments, the audio processing algorithms selectable with the user interface comprises of any of equalization, noise gate, high-pass filter, compressor, de-esser, reverb, echo/delay, chorus and modulation, pitch, or gender effects. In embodiments, the processor has an operational mode for sending and receiving multiple stereo audio streams.

According to another aspect of the disclosure, a gaming audio interface system comprising a plurality of audio inputs, a plurality of audio outputs, a processor and a non-transitory computer-readable storage medium storing instruction that, when executed by the processor, cause the processor to perform a method, the method comprising: A) receiving a first audio signal stream from one of the plurality of audio inputs operatively coupled to a remote executable gaming process; B) receiving a second audio signal stream generated with a transducer coupled to another of the plurality of audio inputs or generated by playback of at least one audio sample stored in memory associated with the processor; C) modifying at least a portion of the second audio signal stream with one of a plurality of audio processing algorithms stored in memory associated with the processor upon user selection thereof; D) combining the first audio signal stream and the second audio signal stream into a combined audio signal stream, and E) providing the combined audio signal stream to one of the audio outputs operatively coupled to a remote executable broadcast process. In embodiments, the audio processing algorithms selectable with the user interface comprises of any of equalization, noise gate, high-pass filter, compressor, de-esser, limiter, reverb, echo/delay, chorus and modulation, pitch, or gender effects.

According to yet another aspect of the disclosure, a method for use with an audio interface system comprising a plurality of audio inputs, a plurality of audio outputs, and a processor, the method comprising: A) receiving a first audio signal stream from one of the plurality of audio inputs operatively coupled to a remote executable gaming process; B) receiving a second audio signal stream generated with a transducer coupled to another of the plurality of audio inputs or generated by playback of at least one audio sample stored in memory associated with the processor; C) modifying at least a portion of the second audio signal stream with one of a plurality of audio processing algorithms stored in memory associated with the processor upon user selection thereof; D) combining the first audio signal stream and the second audio signal stream into a combined audio signal stream, and E) providing the combined audio signal stream to one of the audio outputs operatively coupled to a remote executable broadcast process. In embodiments, the audio processing algorithms selectable with the user interface comprises of any of equalization, noise gate, compressor, high-pass filter, de-esser, reverb, echo/delay, chorus and modulation, pitch, or gender effects.

### DESCRIPTION OF THE FIGURES

Reference will now be made to certain embodiments consistent with the present disclosure, examples of which are illustrated in the accompanying drawings, in which:

FIG. 1 illustrates a perspective view of the gaming audio interface system in accordance with the disclosure;

FIG. 2 illustrates conceptually a top plan view of the gaming audio interface system of FIG. 1 in accordance with the disclosure;

FIG. 3 illustrates conceptually a rear plan view of the gaming audio interface system of FIG. 1 in accordance with the disclosure;

FIG. 4 illustrates conceptually a block diagram of the logical internal organization of the gaming audio interface system of FIG. 1 in accordance with the disclosure;

FIG. 5 illustrates conceptually the signal flow path in summing notes architecture of the gaming audio interface system of FIG. 1 in accordance with the disclosure;

FIG. 6 illustrates schematically the audio routing configuration of the gaming audio interface system of FIG. 1 configured in a basic mode of operation in accordance with the disclosure;

FIG. 7 illustrates schematically the audio routing configuration of the gaming audio interface system of FIG. 1 configured in an advanced mode of operation in accordance with the disclosure;

FIG. 8 illustrates conceptually a graphic user interface generated by a control program in accordance with the disclosure;

FIG. 9 illustrates conceptually a graphic user interface generated by a control program in accordance with the disclosure;

FIG. 10 illustrates conceptually a graphic user interface generated by a control program in accordance with the disclosure; and

FIG. 11 illustrates conceptually a graphic user interface generated by a control program in accordance with the disclosure.

### DETAILED DESCRIPTION

The present disclosure will be more completely understood through the following description, which should be read in conjunction with the drawings. In this description, like numbers refer to similar elements within various embodiments of the present disclosure. The skilled artisan will readily appreciate that the methods, apparatus and systems described herein are merely exemplary and that variations can be made without departing from the spirit and scope of the disclosure. The terms comprise, include, and/or plural forms of each are open ended and include the listed parts and can include additional parts that are not listed. The term and/or is open ended and includes one or more of the listed parts and combinations of the listed parts.

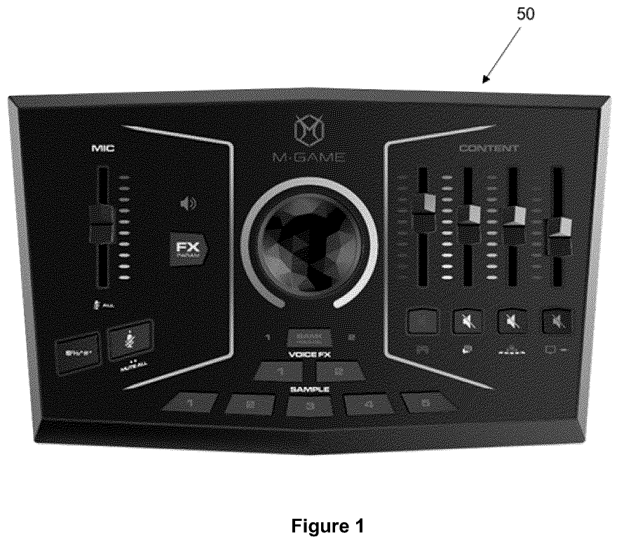

Disclosed is a gaming audio interface system of FIG. 1 system designed specifically for the streaming requirements of a gaming environment. The system provides all of the necessary audio I/O and controls in a single device with an easy to use user interface having underlying control panel software that facilitates setup, advanced configuration of onboard controls and access to advanced settings such as headphone mix settings, and configuring effects and sound enhancements, etc.

The system utilizes an integrated solution for enhanced audio for headphones and for headset mic, as well as onboard DSP for equalization, noise gate, compressor, de-esser (compensation of sibilance) and high-pass filter effects, as well as modulation/time based and pitch effects (Reverb, Echo/Delay, Pitch, and Gender). In embodiments, such audio processing functionality may be implemented with a dedicated semiconductor device.

The disclosed device 50 enables control of user stream, including any of the following functions:
Adjust the user's stream mix with individual volume fader and mute controls for the user microphone, game, chat, sampler, system and aux input
Adjust the user microphone volume to a game PC and headphone mix independent of the game stream
Mute or censor the user microphone, trigger samples, and apply effects instantly at the push of a button
Configurable Gate, Compressor, equalization, high-pass filter, and De-esser effects processing functions for optimizing the user microphone audio signal
Configure Voice Change Effects enables instantly changing the pitch and gender of the user voice
Features an ultra-reliable low-latency USB audio driver

The system utilizes a software control panel for editing controls, signal routing, and other audio and LED routing/selection. The control panel enables control launching, recording, editing, loading samples, and handling of MIDI to HID Control for key-binding the various buttons/controls of the user interface as well as assigning images to samples and effects.

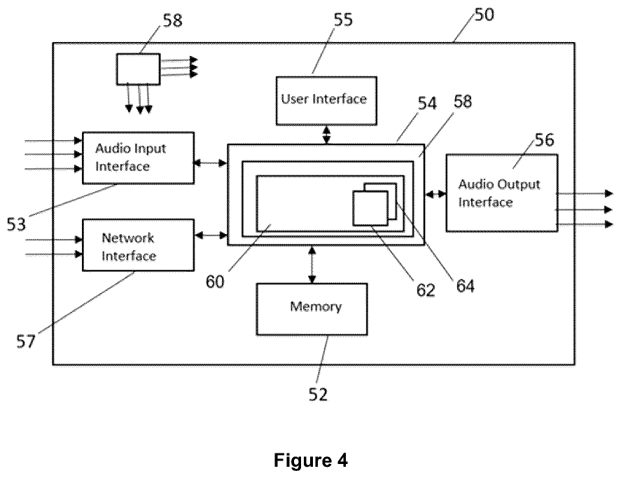

FIGS. 1-3, inter alia, illustrate a device 50 capable of implementing the methods and techniques described herein. As illustrated in the conceptual block diagram of FIG. 4, device 50 comprises, memory 52, audio input interface 53, a processor/audio engine 54, a user interface 55, an audio output interface 56, network interface 57, and power supply 59. Operating system 60 interfaces with processor 54 via a layer of firm ware 58, which enables execution of the software control panel 62 and one or more applications 64 under the control of operating system 60 to provide the various recording, editing, and other audio signal processing functions described herein. Each of the major components of device 50 is described in greater detail herein.

FIG. 4 illustrates conceptually a block diagram of the logical internal organization of the device 50. As noted previously, device 50 comprises a memory 52, an audio input interface 53, a processor/audio engine 54, a user interface control surface 55, an audio output interface 56, a network interface 57, and power supply 59. In one implementation the processor 54 maybe implement with a special purpose digital signal processing (DSP) chip including any associated RAM, ROM, working registers and other associated memory. Processor/audio engine 54 of device 50 is responsible for sampling, processing, and mixing any of the audio streams received through the audio input interface 53. One or more executable code modules storable in RAM or ROM associated with processor 54 may implement the algorithms necessary to perform the processes described herein as well as to perform the audio signal processing available through the user interface 55 of device 50.

### Control Surface

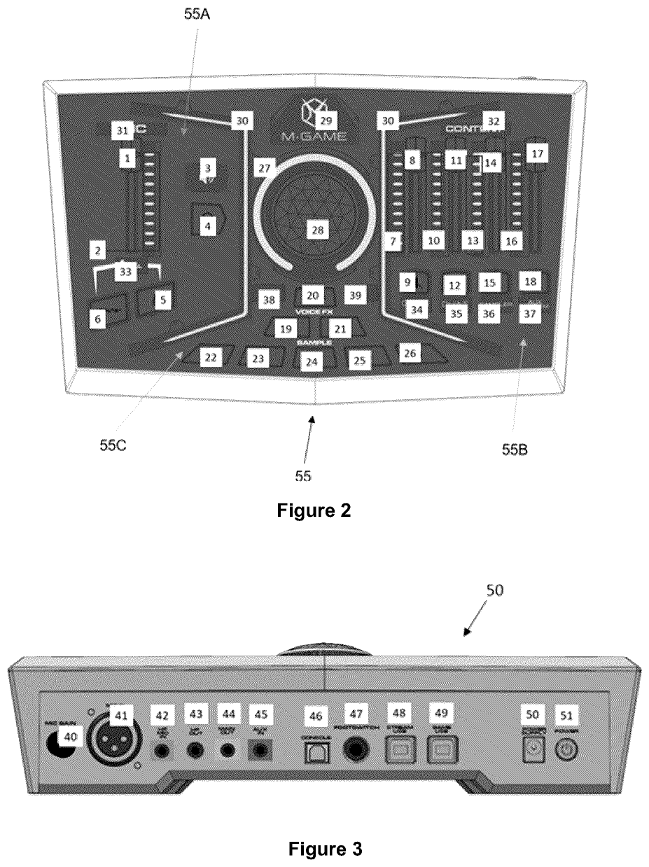

FIGS. 1-4 illustrate various views of the exterior of the console device 10 in accordance with an embodiment of the disclosure. More specifically, FIGS. 1-2 illustrate a front perspective and top views of an exemplary embodiment of device 50. User interface control surface 55, includes the various dedicated physical controls and lighting elements, capable of interfacing with the internal processing, memory, audio interface and control and logic components of device 50. The control surface 55 itself is programmed over MIDI by the control panel software 62 as explained in further detail herein. The physical controls and LEDs buttons are controlled by firmware which interfaces with the actual physical circuitry. The control panel software 62 enables the user to perform all of the following functions:
Easy guided setup
Adjust advanced audio routings including a separate headphone mix from stream
Configure on-board controls and bind them to the user keyboard
Customize the onboard RGB LEDs to match the rest of the user streaming setup
Import audio samples and images from the user's PC library

In embodiments, control surface 55 may be arranged into multiple section 55A, 55B and 55C, as illustrated in FIG. 2. Section 55A of control surface 55 generally includes controllers necessary for controlling an audio signal generated by a transducer, such as a microphone, connected to one of the audio input ports on the rear panel of device 50. The implementation and function of the various interface elements in Section 55A are described hereafter.

Mic Level Fader 1 may be implemented with a slidable potentiometer, the position of which controls the mic volume being sent to the USB port. This is not a “gain” control. When fully lowered, it needs to effectively mute the mic. The routing of this fader is controlled via the software control panel. The microphone's fader can be sent to any of the USB audio output channels.

Mic Level Fader LEDs 2 may be implemented with a plurality, e.g. ten, individually controlled RGB LEDs that display the current position of the Mic Level Fader 1.

Speakers LED indicator 3 may be implemented with an RGB LED lens that lights up to show that the main knob is currently controlling the output level of the ⅛ main and headphone TRS out 41.

FX Parameter Button 4, may be implemented with a backlit RGB LED button, and, when pressed, will switch the main knob between controlling the currently selected effect's parameter and the volume level for the ⅛″ Headphone output and ⅛″ main output. This button will light up to show that the main knob is currently controlling the selected effect's parameter. This button will be backlit by an RGB LED.

Configurable Mic Mute Button 5 may be implemented with a backlit RGB LED button, and, when pressed, can be configured to mute the mic audio signal being sent to all audio streams, the chat stream, or the broadcast stream. This is editable via the control panel. The button is a momentary or latching depending on the software control panel. The LED behavior of this button is configurable via the control panel. Typically when the Mute is active this LED will be brightly lit, when mute is inactive this LED will be dimly lit. The button 5 may be a toggle button.

When this button is double pressed/tapped it will activate the mic mute all selection and activate the MUTE ALL MIC LED icon 33. This will mute the mic going to all audio output streams.

% #@! Button 6 to mute the mic audio signal being sent to all audio streams, the chat stream, or the broadcast stream. This is editable via the control panel. The button is a momentary button. This button can have a unique audio sample assigned to it so that when this button is pressed it will not only mute the incoming mic signal, but also trigger a funny audio clip, or bleep/tone. The LED behavior of this button is configurable via the control panel. Typically when the % #@! is active this LED will be brightly lit, when % #@! is inactive this LED will be dimly lit.

MIC game LED 31 may be implemented with an RGB LED that can have its associated color changed via the control panel software.

Section 55B of control surface 55 generally includes fader controllers and LED Fader indicators necessary for controlling audio stream levels for each of four channels as well as mute buttons and status LEDs for each channel. The implementation and function of the various interface elements in Section 55B are described hereafter.

Game Level Fader LEDs 7 may be implemented with a plurality, e.g. ten, of individually controlled RGB LEDs that display the current position of the Game Level Fader 8.

Game Level Fader 8 may be implemented with a slidable potentiometer, This fader will adjust the volume of the game audio being sent to the USB port. This level will be identical to what audio is being sent to the headphones unless the headphone/speaker mix is changed in the control panel.

Game Mute Button 9 may be implemented with an RGB backlit button and, when pressed, will mute the game audio signal being sent to the USB outputs configured in the control panel. The button is a momentary or latching depending on the software control panel. The LED behavior of this button is configurable via the control panel. Typically when the Mute is active this LED will be brightly lit, when mute is inactive this LED will be dimly lit.

Chat Level Fader LEDs 10 may be implemented with a plurality, e.g. ten, of individually controlled RGB LEDs that display the current position of the fader 11.

Chat Level Fader 11 may be implemented with a slidable potentiometer, the position of which controls the volume of the chat audio being sent to the USB, which is the same audio signal being sent to the headphones unless the headphone/speaker mix is changed in the control panel.

Chat Mute Button 12 may be implemented with an RGB backlit button and, when pressed, will mute the chat signal being sent to the USB port, and main TRS/headphone outputs, unless the headphone/speaker mix is changed in the control panel. The button 12 may be implemented as a momentary button or toggle button, depending on the software control panel implementation.

Sampler Level Fader LEDs 13 may be implemented with a plurality, e.g. ten, of individually controlled RGB LEDs that display the current position of the fader.

Sampler Level Fader 14 may be implemented with a RGB backlit slidable potentiometer, the position of which controls the volume of the sampler audio being sent to the USB port which is the same audio signal being sent to the headphones, unless the headphone/speaker mix is changed in the control panel.

Sampler Mute Button 15 may be implemented with an RGB backlit button and, when pressed, will mute the sampler audio signal being sent to the USB port and main TRS/headphone outputs unless the headphone/speaker mix is changed in the control panel. Button 15 may be implemented as a momentary or toggle depending on the software control panel setting.

System/AUX Level Fader LEDs 16 may be implemented with a plurality, e.g. ten, of individually controlled RGB LEDs that display the current position of the fader.

System/AUX Level Fader 17 may be implemented with an RGB backlit slidable potentiometer, the position of which controls the volume of the System/AUX audio being sent to the USB port and main TRS/headphone outputs, unless the headphone/speaker mix is changed in the control panel.

System/AUX Mute Button 18 may be implemented with an RGB backlit button and, when pressed, will mute the System/AUX audio signal being sent to the USB port and main TRS/headphone outputs, unless the headphone/speaker mix is changed in the control panel. Button 18 may be implemented as a momentary button or toggle button, depending on the software control panel implementation.

Each of Game LED 34, Chat LED 35, Sampler LED 36 and System/AUX LED 37 may be implemented with an RGB LED that can have its associated color changed via the control panel software.

Section 55C of control surface 55 generally includes main line control knob, and buttons relating to selection of effects and samples, and triggering recording in deletion of samples. The implementation and function of the various interface elements in Section 55C are described hereafter.

Effect Button 1 19 may be implemented with an RGB backlit button and, when pressed, will activate a voice effect for the microphone audio signal. This effect is editable in the device 50 control panel software. Other audio signal processing effects can be similarly assigned to this button.

Pressing this button will activate the effect assigned to Voice Effect Button 1 (or 3) for the microphone. This effect is editable in the control panel software.

BANK Button 20 may be implemented with an backlit button and enables changing between a maximum of four effects and 10 samples. The total amount of Effects per bank is two: one assigned to the effect button 1, and one effect assigned to the effect button 2, allowing for a total of four voice effects, 2 per bank. The total amount of Samples per bank is five, allowing for a total of ten samples. The banks will be distinguishable by the Bank 1 and 2 LEDs, voice effect, and sample button LEDs. When this button is pressed and held it will activate a delete mode enabling users to remove the currently assigned sample from a button. When a sample button as no sample assigned a sample button can be pressed and held to trigger recording a sample.

Once a sample has been deleted, the Sample buttons will return to normal use, and the button associated with the deleted sample will no longer be lit. If a user wishes to not delete a sample from a button, they only need to press the delete button again to return the sample buttons to their normal mode. Deleting a sample does not delete the sample of an end user's HD, it only clears the currently assigned sample that is associated with that button. The audio sample will remain on the end user's PC.

Voice Effect Button 2 21 may be implemented with an RGB backlit button that activates a voice effects for the microphone. This effect is editable in the device 50 control panel software. Other effects can be assigned to effect button 21.

Sample 1 Button 22 may be implemented with an RGB backlit button that can initiate sending of a MIDI message to the control panel of device 50 to trigger the audio sample that is currently assigned to button 22. When no sample is assigned to this button, and this button is pressed and held button 22 will trigger the control panel to start recording a sample from any incoming audio. Audio received by the sampler can be configured by the control panel 50.

Sample 2 Button 23 may be implemented with an RGB backlit button that can initiate sending of a MIDI message to the control panel of device 50 to trigger the audio sample that's assigned to this button. When no sample is assigned to this button, and this button is pressed and held it will trigger the control panel to start recording a sample from any incoming audio. Audio received by the sampler can be configured by the control panel 50.

Sample 3 Button 24 may be implemented with an RGB backlit button that can initiate sending of a MIDI message to the control panel of device 50 to trigger the audio sample that is currently assigned to button 24. When no sample is assigned to this button, and this button is pressed and held, button 24 will trigger the control panel to start recording a sample from any incoming audio. Audio received by the sampler can be configured by the control panel 50.

Sample 4 Button 25 may be implemented with an RGB backlit button that can initiate sending of a MIDI message to the control panel of device 50 to trigger the audio sample that is assigned to button 25. When no sample is assigned to this button, and this button is pressed and held, button 25 will trigger the control panel to start recording a sample from any incoming audio. Audio received by the sampler can be configured by the control panel 50.

Sample Button 5 26 may be implemented with an RGB backlit button that can initiate sending of a MIDI message to the control panel of device 50 to trigger the audio sample that is assigned to button 26. When no sample is assigned to this button, and this button is pressed and held, button 26 will trigger the control panel to start recording a sample from any incoming audio. Audio received by the sampler can be configured by the control panel 50.

LED Ring Indicator 27 may be implemented with a 270° LED ring surrounding main knob 28 indicating the currently selected button level. For example, if Headphone/main out level icon is selected 3, the knob 28 will control the headphone/main out volume level, and the LED ring indicator 27 will show no lights when the volume is set to 0%, or half of the lights if the volume is set to 50%, or all of the lights if the volume is set to 100%, or any other value therebetween. When the FX Parameter 4 is selected this LED ring will show the current level state of the assigned voice effect parameter in the control panel 50

FX Param/Headphone/Speakers Main Volume Knob 28 may be implemented with a 360° knob capable of adjusting either the Headphone/Main speakers level or assigned vocal effect parameter depending on the Speakers/FX Param button 4.

M-GAME logo 29 may be implemented with a backlit RGB LED lens lit solid to indicate that the system is powered on.

Each of Side panel LEDs 30 separating section 55C from sections 55A and 55B may be implemented with an RGB LED that can have its associated color changed via the control panel software.

### Rear Panel

FIG. 3 is a rear plan view of device 50, illustrating conceptually the various ports that comprise the audio input interface 53 and audio output interface 56 to enable connection of device 50 to external systems and peripherals. In embodiment, device 50 may include the following connections:
Two USB-B connections for compatibility with both single and dual PC streaming gamer setups
XLR mic connection with premium crystal preamp circuitry features 50 dB of dynamic range plus 24 dB of digital gain via the control panel 50
⅛″ Headset connections for use with most popular gaming headphones and headsets
Stereo ⅛″ output with independent volume level for connecting to speakers
Stereo ⅛″ aux input for connecting mobile devices and more
Optical input for connecting televisions, gaming consoles, such as the PS4 and Xbox One, for receiving PCM data
USB-B connections send high-quality 24-bit 48 kHz audio to your streaming platform

The implementation and function of the various interface elements in the rear panel of device 50 are described hereafter.

XLR input 41 may be implemented with an XLR connector used for connecting XLR microphones. In embodiments, +48V phantom power may be selected from the control panel. The input 38 gain is controlled via a gain knob 40.

TRS headset mic connection 42 may be implemented as a ⅛″ TRS Input and is used for connecting to a headset mic. If a TRS connection is connected through mic connection 39, such input overrides the XLR mic input 38. This requires a headset bias circuit. The mic connection 39 gain is controlled via a gain knob 40

Stereo headphone connection 43 may be implemented as a ⅛″ TRS Output and is used for connecting to headphones.

Speakers Main Out 44 may be implemented as a Main Stereo ⅛″ TRS Output and serves as the main Stereo output, typically for connection to speakers.

Aux Input 45 may be implemented with as a 3.5 mm stereo Aux input used for connecting to an mp3 player, phone, or other device for playing music or connecting to a separate chat application (Skype, Dischord, etc.)

Optical Input 46 may be implemented with an Optical connector for connecting to the outputs of a television, PS4, or XBOX One, or other gaming device to receive PCM data.

Game/Stream Connection 48 may be implemented with a USB B Female connector and may be used for connecting to a host PC, typically running the stream and the game. Connection 48 enable audio transmission between the device 50 and a host PC. The device 50 must be connected to a host via the USB Port in order to send data back and forth.

Game Connection 49 may be implemented with a USB B Female connector and may be used for connecting to a second host PC running just the game or game and chat audio. Connection 49 enable audio transmission between the device 50 and a second host PC.

On/Off Button 51 may be implemented with a push button locking tact switch and is used to turn power to the device 50 on or off. Power Supply Connector 50 is used for connecting an external power supply.

### Operating Modes/Configuration

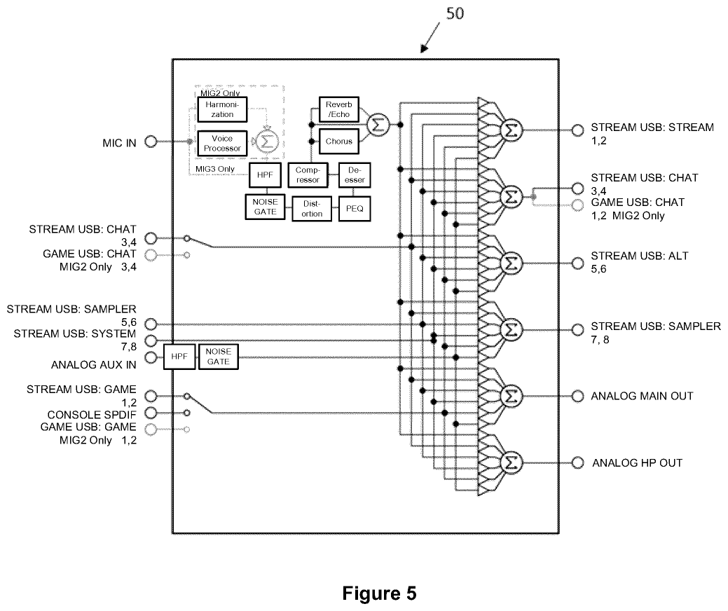

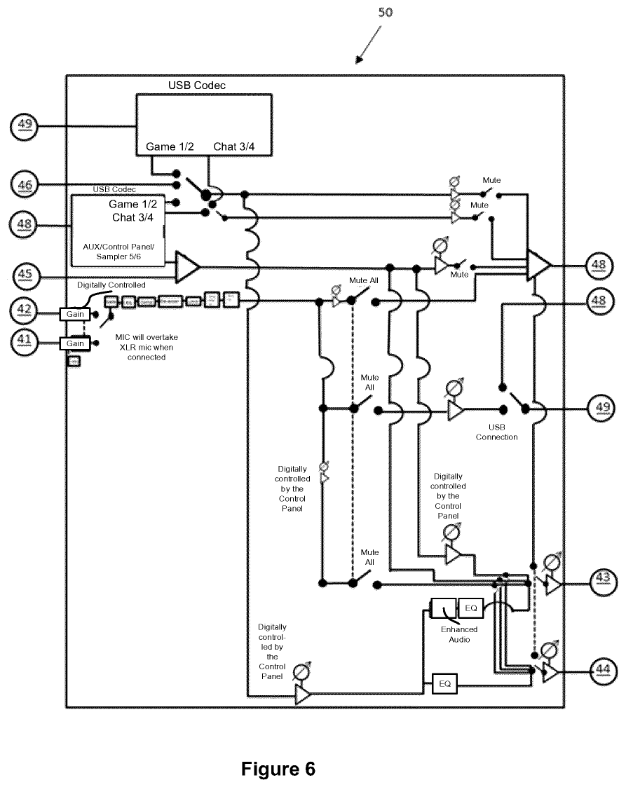

FIG. 5 illustrates conceptually the of signal flow path architecture between the various input and output connections and intermediate summing nodes 80A-F of device 50. FIG. 6 illustrates schematically the audio routing configuration of device 50 configured in a basic mode of operation for streaming from a single computer executing game process. To utilize device 50 in this configuration, a microphone may be connected to XLR input 41 and headphones may be connected to stereo headphone connection 43, or, or a headset with integrated microphone are connected to TRS headset mic connection 42. Next, the streaming/gaming computer is connected to Game/Stream Connection 48 on the rear panel of device 50. In this configuration, the graphical user interfaces generated by software control program 62 be reviewable on a display associated with the connected streaming/gaming computer.

Optionally, the audio output from a television, gaming console, e.g. PS4, or XBOX One, or other gaming device, or a television may be connected to Optical Input 46 on the rear panel of device 50. to receive PCM data. In addition, external speakers may be optionally connected to Speakers Main Out 44 on the rear panel of device 50. Further, a media player, such as an mp3 player, phone, or other device for playing music or connecting to a separate chat application (Skype, Dischord, etc.) may optionally be connected to Aux Input.

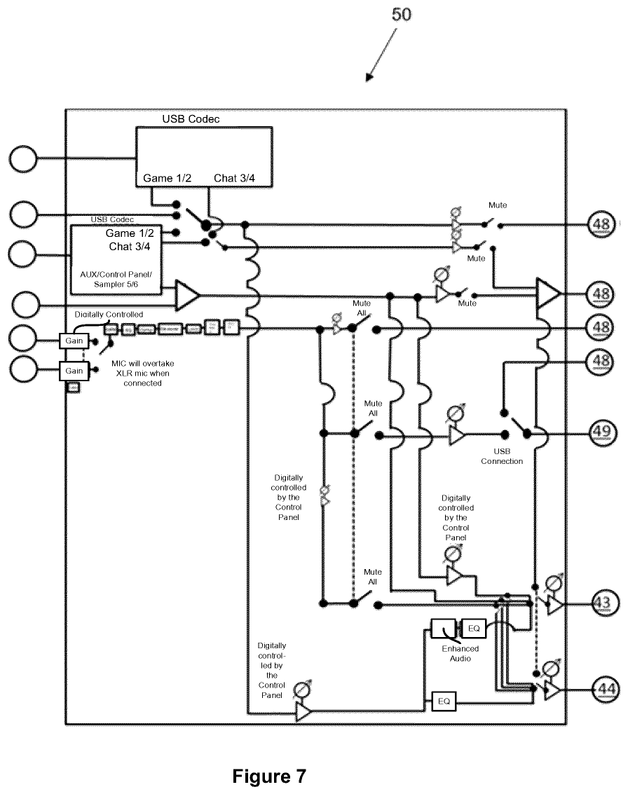

FIG. 7 illustrates schematically the audio routing configuration of device 50 configured in an advanced mode of operation for streaming with dual computers, one of which executes a gaming process and another of which executes a broadcast/streaming process. In this mode of operation a microphone and headphones or a headset with integrated microphone may be connected to device 50 as described with reference to the basic mode of operation. Next, the computer executing the primary streaming/game process is connected to Game/Stream Connection 48 on the rear panel of device 50 and the computer executing the audio chat/gaming process is connected to Game Connection 49 on the rear panel of device 50. In this configuration, the processor has an operational mode for sending and receiving four channels of stereo USB audio signals due in part to the dual USB-B connections compatibility with both single and dual PC streaming gamer setups. The optional connections of speakers and media player described with reference to the basic mode of operation are similar in the advanced mode of operation. In FIG. 7, similarly illustrated symbols have the same reference numbers as shown in FIG. 6 herein if not shown.

### Software

In addition to the control surface 55, device 50 utilizes a software control panel 62 for editing controls, signal routing, and other audio and LED routing/selection. The software control panel 62 enables control launching, recording, editing, loading samples, and handling of MIDI to HID Control for key-binding the various buttons/controls of the user interface and is viewable on a connected device having a visual display.

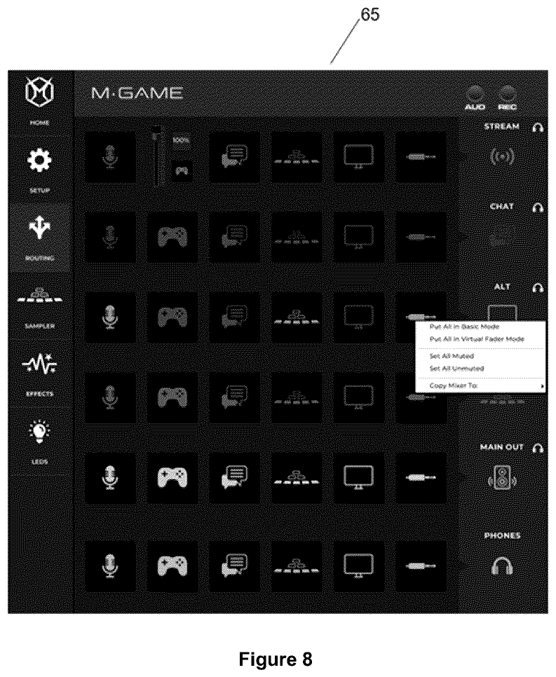

In embodiments, control panel software 62 may be implemented as an application having a robust graphic user interface 65, as illustrated in FIG. 8, with a variety of different virtual controls allowing the user to set up system and adjust levels for connected peripherals, route various connections between the audio input interface 53 and audio output interface 56, adjust LED display colors on control surface 55, and set parameters for the associated sampler and effect algorithms executable by audio engine 54, as illustrated.

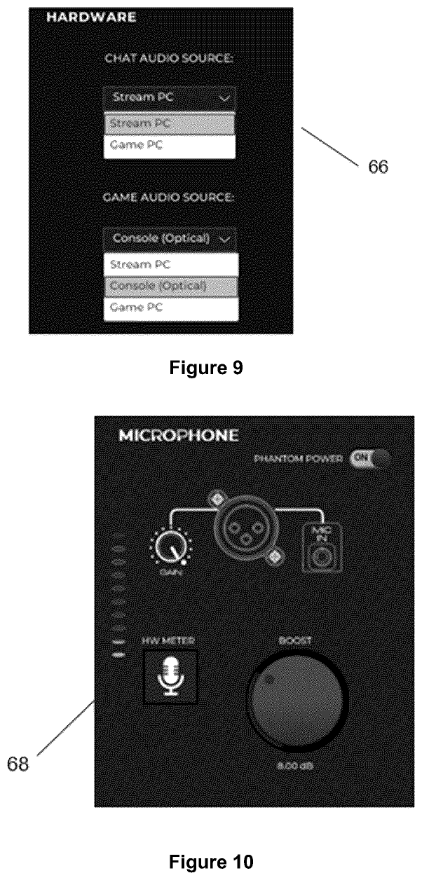

In embodiments, control panel software 62 presents graphic user interface 66, as illustrated in FIG. 9, with a number of menu boxes enabling the user to select either a game PC or stream PC as the chat audio source, as well as enabling the user to select either a game PC, stream PC, or console optical port as the game audio source.

In embodiments, control panel software 62 presents graphic user interface 68, as illustrated in FIG. 10, with a number of graphic controls, then a power switch and level meter which enable selecting one of the microphones inputs on the rear panel of device 50 and adjusting the signal boost level.

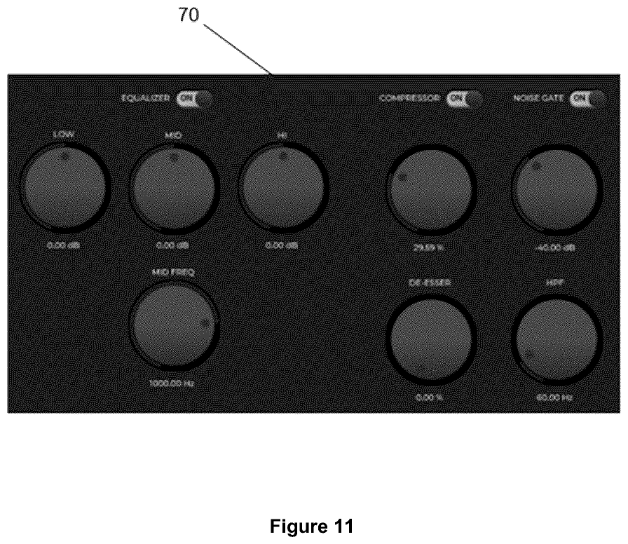

In embodiments, control panel software 62 presents graphic user interface 70, as illustrated in FIG. 11, with a number of graphic controls for the parameters of various effects. Specifically, interface 70 provides a switch for selecting an equalization signal processing algorithm to be performed by audio engine 54 on the incoming microphone signal and a variable control for setting the mid frequency of the equalization response profile. Interface 70 also provides a switch for selecting a compression signal processing algorithm and a variable control for setting the amount of compression desired. Interface 68 further provides a switch for selecting a noise gate signal processing algorithm to be performed by audio engine 54 on the incoming microphone signal and a variable control for setting the amount of compression desired. Interface 70 still further provides a variable control for setting the amount of desired de-esser (compensation of sibilance) signal processing algorithm to be performed by audio engine 54 on the incoming microphone signal. Interface 70 still further provides a variable control for setting the cut off frequency of a high-pass filter algorithm to be performed by audio engine 54 the incoming microphone signal. Similar virtual switches and controls may be provided for other audio signal processing effects including, but not limited to, distortion, chorusing (comb filtering), flanging, echo/delay, and reverberation. In embodiments, the processor of audio engine 54 may perform any of the above-described effect algorithms in the sequential order indicated in FIG. 5, or any other sequential order, as well as executing one or more signal processing effects algorithms in parallel at any point in the audio signal path.

In embodiments, the system requirements to utilize the device 50 may be Windows 10 operating system, a host USB port high-speed 2.0 or higher, and support of the USB 3.0 protocol. In embodiments, the operating system 60 and applications 62 as well updates and/or revisions thereto may be made available to a user via download over a network or data port. In embodiments, the device 50 may be compatible with any of the following applications:
Windows
Twitch
Youtube
OBS
Stream Labs OBS
Stream Elements
Xsplit
Audacity
Ableton Live, Live Lite
Steinberg Cubase
Avid Pro Tools, Pro Tools|First
Sony Vegas
Adobe Premiere
Mixer (Windows 10 only)
Discord
Raidcall
Mumble
Teamspeak
In-Game Voice Chat

The device 50 will use an external power supply to supply +48V to condenser mics, and for supply power for lighting LEDs. In embodiments, the external power supply (not shown) may comprise an internal transfer

The device 50 may be provided with a breakout cable implemented with a Female CTIA TRRS to Y TRS mic/TRS phones male cable. The device 50 may have the audio performance requirements listed in Tables 1-3 below:

TABLE 1
Mic Input

| | TARGET | |
|---|---|---|
| EIN (max gain, 40 ohm source) | −126 | dB |
| Gain Range | 50 dB Analog +24 db Digital | |
| SNR (A-weighted) | 104 | dB |
| Frequency response (20 Hz-20 kHz) | +/−0.1 | dB |
| Max Input | +4 | dBu |

TABLE 2
Main TRS Outputs

| | TARGET | |
|---|---|---|
| THD (%, −1 dBFS output) | 0.001% | |
| SNR (A-weighted) | 104 | dB |
| Frequency Response (20 Hz-20 kHz) | +/−0.2 | dB |
| Max Output Level | +5.5 | dBu |

TABLE 3
Headphone Outputs

| | TARGET | |
|---|---|---|
| Power | 60 mW/Ch, 32 ohms | |
| Frequency response (20 Hz-20 kHz) | +/−0.5 | dB |
| THD + N (1 khz, max gain, A-weighted) | 0.01 | |
| SNR | −100 | dB |

In embodiments, the disclosed device 50 may be sold alone or as a kit together with any of the following items:
(2) 1M USB A to USB B Cables
2M optical cable (toslink to toslink)
2M ⅛″ to ⅛″ TRS cable
CTIA TRRS to TRS mic/TRS phones adapter for gaming headsets
Software download Card
User Guide/other documentation

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and, accordingly, all suitable modifications and equivalents falling within the scope of the disclosure may be resorted to.

Computer programs, program modules, and code based on the written description of this specification, such as those used by the microcontrollers, are readily within the purview of a software developer. The computer programs, program modules, or code can be created using a variety of programming techniques. For example, they can be designed in or by means of Java, C. C++, assembly language, or any such programming languages. One or more of such programs, modules, or code can be integrated into a device system or existing communications software. The programs, modules, or code can also be implemented or replicated as firmware or circuit logic.

Another aspect of the disclosure is directed to a non-transitory computer-readable medium storing instructions which, when executed, cause one or more processors to perform the methods of the disclosure. The computer-readable medium may include volatile or non-volatile, magnetic, semiconductor, tape, optical, removable, non-removable, or other types of computer-readable medium or computer-readable storage devices. For example, the computer-readable medium may be the storage unit or the memory module having the computer instructions stored thereon, as disclosed. In some embodiments, the computer-readable medium may be a disc or a flash drive having the computer instructions stored thereon.

While several embodiments of the disclosure have been shown in the drawings, it is not intended that the disclosure be limited thereto, as it is intended that the disclosure be as broad in scope as the art will allow and that the specification be read likewise. Any combination of the above embodiments is also envisioned and is within the scope of the appended claims. Moreover, while illustrative embodiments have been described herein, the scope of any and all embodiments include equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. An apparatus for mixing gaming audio signals comprising:
a plurality of audio inputs at least one of which is configurable for operative coupling to a remote executable gaming process generating a first audio signal stream;
a plurality of audio outputs at least one of which is configurable for operative coupling to a remote executable broadcast process;
a user interface comprising a plurality of controllers; and
a processor operatively coupled to the plurality of audio inputs, the plurality of audio outputs, a memory and user interface and having an operational mode configured to:
receive a second audio signal stream generated with a transducer coupled to another of the plurality of audio inputs different from the at least one audio input;
modify the second audio signal stream with one of a plurality audio processing algorithms selectable with the user interface;
generate a third audio signal stream comprising audio signal playback of at least one audio sample stored in the memory;
combine the first audio signal stream and one of the second audio signal stream and third audio signal stream into a combined audio signal stream, and
provide the combined audio signal stream to the at least one audio outputs configurable for operative coupling to the remote executable broadcast process.

2. The apparatus of claim 1 wherein plurality audio processing algorithms comprises any of equalization, noise gate, compression, de-esser, chorus or high-pass filter effects.

3. The apparatus of claim 1 wherein plurality audio processing algorithms comprises any of reverb, delay or modulation/time based effects.

4. The apparatus of claim 1 wherein plurality audio processing algorithms comprises any of pitch shifting or gender facts.

5. The apparatus of claim 1 wherein the plurality of audio inputs comprise multiple USB ports.

6. The apparatus of claim 5 wherein the plurality of audio outputs comprise multiple USB ports.

7. The apparatus of claim 6 wherein the processor has an operational mode for sending and receiving multiple stereo audio streams.

8. An audio interface system comprising a plurality of audio inputs, a plurality of audio outputs, a processor and a non-transitory computer-readable storage medium storing instruction that, when executed by the processor, cause the processor to perform a method, the method comprising:
A) receiving a first audio signal stream from one of the plurality of audio inputs operatively coupled to a remote executable gaming process;
B) receiving a second audio signal stream generated with a transducer coupled to another of the plurality of audio inputs or generated by playback of at least one audio sample stored in memory associated with the processor;
C) modifying at least a portion of the second audio signal stream with one of a plurality of audio processing algorithms stored in memory associated with the processor upon user selection thereof;
D) combining the first audio signal stream and the second audio signal stream into a combined audio signal stream, and
E) providing the combined audio signal stream to one of the audio outputs operatively coupled to a remote executable broadcast process.

9. The system of claim 8 wherein plurality audio processing algorithms comprises any of equalization, noise gate, compression, de-esser, chorus or high-pass filter effects.

10. The system of claim 8 wherein plurality audio processing algorithms comprises any of reverb, delay or modulation/time based effects.

11. The system of claim 8 wherein plurality audio processing algorithms comprises any of pitch shifting or gender facts.

12. The system of claim 8 wherein the plurality of audio inputs comprise multiple USB ports.

13. The system of claim 12 wherein the plurality of audio outputs comprise multiple USB ports.

14. The system of claim 8 wherein the processor has an operational mode for sending and receiving multiple stereo audio streams.

15. A method for use with an audio interface system comprising a plurality of audio inputs, a plurality of audio outputs, and a processor, the method comprising:
A) receiving a first audio signal stream from one of the plurality of audio inputs operatively coupled to a remote executable gaming process;
B) receiving a second audio signal stream generated with a transducer coupled to another of the plurality of audio inputs or generated by playback of at least one audio sample stored in memory associated with the processor;
C) modifying at least a portion of the second audio signal stream with one of a plurality of audio processing algorithms stored in memory associated with the processor upon user selection thereof;
D) combining the first audio signal stream and the second audio signal stream into a combined audio signal stream, and
E) providing the combined audio signal stream to one of the audio outputs operatively coupled to a remote executable broadcast process.

16. The method of claim 15 wherein plurality audio processing algorithms comprises any of equalization, noise gate, compression, de-esser, chorus or high-pass filter effects.

17. The method of claim 15 wherein plurality audio processing algorithms comprises any of reverb, delay or modulation/time based effects.

18. The method of claim 15 wherein plurality audio processing algorithms comprises any of pitch shifting or gender facts.

19. The method of claim 15 wherein the plurality of audio inputs comprise multiple USB ports.

20. The method of claim 18 wherein the plurality of audio outputs comprise multiple USB ports.

21. The method of claim 19 wherein the processor has an operational mode for sending and receiving multiple stereo audio streams.

22. An apparatus for mixing gaming audio signals comprising:
a plurality of audio inputs at least one of which is configurable for receiving a first audio signal stream from a remote executable gaming process;
a plurality of audio outputs at least one of which is configurable for sending a combined audio signal stream to a remote executable broadcast process;
a processor operatively coupled to the plurality of audio inputs, the plurality of audio outputs and having an operational mode configured to:
receive a second audio signal stream generated with a transducer coupled to another of the plurality of audio inputs different from the at least one audio input;
combine the first audio signal stream and the second audio signal stream into the combined audio signal stream, and
transmit the combined audio signal stream to the remote executable broadcast process.

23. The apparatus of claim 22 wherein first audio signal stream is received in digital format.

24. The apparatus of claim 22 wherein combined audio signal stream is transmitted in digital format via a UBS connection.

25. The apparatus of claim 22 wherein the at least one audio input is configurable for operative coupling to a gaming process executing on the first processor and the at least one audio output is configurable for operative coupling to a broadcast process executing on the second processor, different from the first processor.
